(19) United States
(12) Patent Application Publication
(10) Pub. No.: US 2022/0299218 A1
(43) Pub. Date: Sep. 22, 2022

(54) SYSTEM FOR HUMIDIFYING AIR IN MULTI-STOREY STRUCTURE

(71) Applicant: Ilya A. Novgorodov, Yekaterinburg (RU)

(72) Inventor: Ilya A. Novgorodov, Yekaterinburg (RU)

(21) Appl. No.: 17/639,501

(22) PCT Filed: Apr. 27, 2021
(86) PCT No.: PCT/RU2021/050111

§ 371 Date: Mar. 1, 2022

(30) Foreign Application Priority Data
May 21, 2020 (RU) 2020116690

(51) Int. Cl. F24F 6/14

(52) U.S. Cl. CPC F24F 6/14; F24F 2006/008

(57) ABSTRACT

The invention relates to air conditioning technology and can be used for creating a comfortable indoor climate in multi-storey structure. More particular it relates to maintaining a sufficient level of air humidity in apartment buildings, office blocks and the like. The invention makes it possible to systemize and control a system for humidifying air in multi-storey structure.

The invention relates to the air conditioning technology and is provided in general to create comfortable microclimate conditions in multistoried buildings, in particular, for sustaining sufficient level of air humidity in apartment buildings, office buildings, and similar buildings.

There are known solutions for maintaining air humidity at a certain level in multistoried buildings by means of centralized installation of a moisturizer/evaporator in an air exhaust system of a building. One of the prior art examples is the heating type steam humidifier Hygromatik HL90 CP, HeaterLine Series with Comfort Plus control system (http://www.aerostandart.ru/parouvlazhnitel-nagrevatelnogo-tipa-hygromatik-hl90-cp-serii-heaterline-s-sistemoj-upravleniya-comfort-plus/). One of the drawbacks of this solution is the need for a forced ventilation system, the second drawback is the impossibility of onsite adjustment of humidity in certain areas of the building, the third drawback is high cost of installation due to the required design of plenum ventilation, as well as restrictions as to where it can be mounted; the fourth drawback is high maintenance cost since steam generation is provided by electric heaters which consume a great deal of electricity, as well as the evaporation leaves scaling on the heaters, due to which the life of the heater is limited to 2-3 washes of the heaters from scaling, after which the heater requires replacement.

The object of the invention is to ensure greater flexibility of the system embodiments since it has no limitation as to the number of consumers per floor and no limitation as to the maximum number of floors.

This problem is resolved as follows: the air humidification system for a multistoried building includes a water supply line from the system of centralized water supply, a water treatment plant, a central high pressure pump, a central control unit for the system, a set of hydraulic accumulators from which the central high pressure water line and the drainage flushing water line are being directed, and from the central high pressure water line the floor-by-floor looped for flushing high pressure water lines are branched out, and connected to consumers; each consumer has its own hydraulic system that includes spray nozzles for adiabatic humidification, hydraulic fixtures, dispersion valves, hydrostats, a panel for the adjustment of indoor humidity that maintains air humidity at a preset level; the control and operation of which are performed using a consumer-side control panel, while the system's central control unit is configured to acquire data from the consumer-side control panels. The set of hydraulic accumulators is one or several interconnected membrane-type storage containers.

The invention allows to systematize and centralize the system of air humidification in a multistoried building by applying adiabatic, high pressure nozzle-type water spraying, where the source of high pressure is centralized by way of combining pressure water lines of a floor into the integral pressure water line with the possibility of its subsequent merging into a single pressure water line of the entire building.

### DESCRIPTION OF THE DRAWING

FIG. 1 is an overall diagram of the arrangement of the adiabatic system for humidifying air in multi-storey structure.

### DETAILED DESCRIPTION OF THE INVENTION

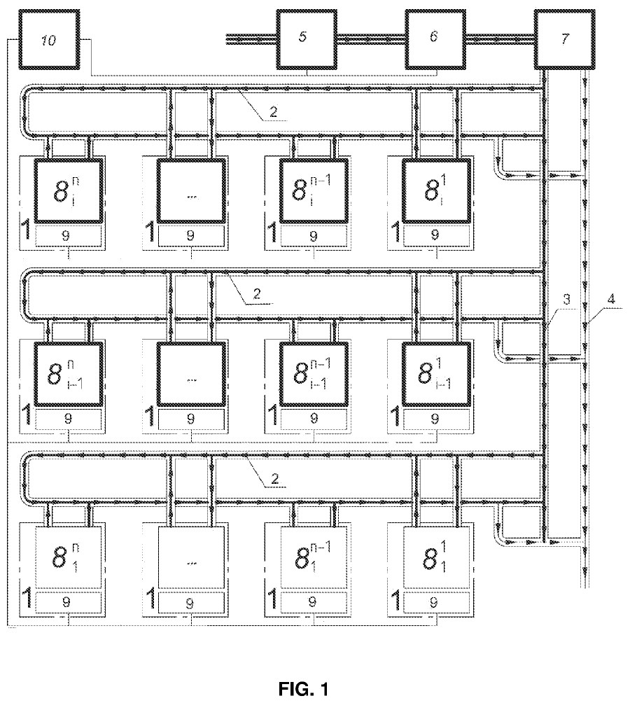

The diagram of FIG. 1 shows the main configuration items, such as apartment/office/premises 1, floor-by-floor 2 and central 3 high pressure water lines (pressure is maintained within the 55 Bar-70 Bar range), drainage water line 4 for flushing, water treatment plant (osmosis for water conditioning) 5, central high pressure pump 6 and set of hydraulic accumulators 7, x number of consumers 8, consumer-side control panel 9, the system's central control panel 10.

Operating principle of the system is as follows.

Unconditioned water from central water supply system of the building is supplied to the water treatment plant 5. After complete treatment water is supplied to the high pressure pump or a set of pumps 6, where from it is supplied under high pressure to storage accumulators 7, which serve to maintain constant pressure in the central high pressure water line 3. The central high pressure water line 3 goes through all the building's floors, and the maximum number of floors is limited by capacity of the equipment. At the required bays from the central high pressure water line the floor-by-floor, looped for flushing high pressure water lines are branched out 2, and they are directly connected to a specific consumer 8. The number of possible consumers, just as the number of floors, is limited by capacity of the water treatment equipment 5, parameters of the high pressure pump or a set of pumps 6 and the set of hydraulic accumulators 7. The consumer 8 is a certain apartment/office in a building, inside the consumer's premises 8 a hydraulic system is set up consisting of hydraulic fixtures and construction features as required for proper operation of the system. Adiabatic high pressure spraying nozzles are installed in the premises designated by the consumer; these nozzles maintain humidity at a preset level. Humidity level, as well as the operation of nozzles, is controlled by the consumer-side control panel 9, which is an electronic chip with a processor operating as per the program enabling the required behavior of the room's system 1. Data from the control panel 9 arrive at the central control unit 10 of the entire building, which is also a microchip with a processor operating as per the program enabling the required behavior of the entire system. The central control unit 10 is also responsible for operating the water treatment plant 5, the high pressure pump or a set of pumps 6, as well as all the hydraulic fixtures and fixtures ensuring setting up of certain scenarios of the system's operation, particularly, openings when necessary of consumer-side valves for the supply of high pressure water to the hydraulic system of the consumer's apartment/office/premises to ensure adequate actuation of the humidifying nozzles, as well as to ensure maintenance operations, such as flushing, due to water release from floor-by-floor high pressure water lines and the central high pressure water line into the drainage system, which is connected to the central waste water disposal system of the building.

The consumer 8 (apartment/office/premises 1) is understood as premises or a group of premises with adiabatic humidification spraying nozzles installed inside, as well as hydraulic fixtures (for instance, high pressure hoses, fittings, manifolds for distributor valves, hydrostats and a panel of indoor humidity adjustment. The operating logic is to monitor indoor moisture level with hydrostats; once it is reduced below a preset level the control panel 9 sends a signal to open the humidification nozzles, and once the preset maximum humidification is achieved the control panel 9 sends a signal to close the nozzles. Connection of the consumer 8 is performed by cutting two feed pipes into the floor-by-floor pressure water line, and in turn the floor-by-floor pressure water line is also connected with two pipes to the central pressure water line.

The central pressure water line integrates all the building floors or a group of floors into a single line which is fed by the pressure station that includes the water treatment plant, the central high pressure pump, and the set of hydraulic accumulators.

The water treatment plant 5 consists of the system of filters with varying filtration levels, as well as the system of reverse osmosis.

The central high pressure pump or a set of high pressure pumps is a single pump or several pumps integrated in a circuit, which deliver high pressure to the high pressure water line.

The set of hydraulic accumulators is one or several interconnected membrane-type storage containers.

The consumer-side control panel actuates distribution valves responsible for the opening and start of distribution of liquid based on data received from the hydrostat, and also it allows the consumer to set the range of start and stop of humidification.

The central control unit includes a microchip with a processor and operates all the consumer-side controls, as well as switches on and off the high pressure central pump (or a set of pumps) based on their data.

The drainage line for flushing is a pipe, through which water from the high pressure water line enters the central waste water discharge system during water release or water flushing.

The invention relates to the air conditioning technology and is provided in general to create comfortable microclimate conditions in multistoried buildings, in particular, for sustaining sufficient level of air humidity in apartment buildings, office buildings, and similar buildings. The system for air humidification in a multistoried building includes a water supply line from the system of centralized water supply, a treatment plant, a central high pressure pump, a central control unit for the system, a set of hydraulic accumulators, to which the central high pressure water line and the drainage flushing water line are fed, and from the central high pressure water line the floor-by-floor, looped for flushing high pressure water lines are branched out, and they are connected to consumers, each of which has its own hydraulic system that includes spray nozzles for adiabatic humidification, hydraulic fixtures, dispersion valves, hydrostats, a panel for the adjustment of indoor humidity that maintains air humidity at a preset level, the control and operation of which are performed using a consumer-side control panel, while the system's central control unit is configured to acquire data from the consumer-side control panels. The set of hydraulic accumulators is one or several interconnected membrane-type storage containers. The invention allows to systematize and centralize the system of air humidification in a multistoried building. 1 subordinate claim,

The advantages of the air humidification system of the invention include:
Lack of need for supply ventilation system,
Possibility of selective installation in isolated premises with air humidity adjustment of each room (premises),
Lower cost due to centralization of the source of high pressure and lack of ancillary equipment.
Low maintenance cost

1. (canceled)

2. (canceled)

3. A system for humidifying air in multi-storey structure, comprising: a water supply line extending from a system of centralized water supply, a treatment plant, a central high pressure pump, a central control unit for a system, a set of hydraulic accumulators, a central high pressure water line and a drainage flushing water line extending from said hydraulic accumulators; multiple floor-by-floor high pressure water lines looped for flushing extend from the central high pressure water line, multiple consumers each having own hydraulic system are connected to said floor-by-floor high pressure water lines; each said consumer hydraulic system comprises multiple elements including spray nozzles for adiabatic humidification, hydraulic fixtures, dispersion valves, hydrostats, a panel for the adjustment of indoor humidity, said multiple elements maintain air humidity at a preset level; control and operation of said multiple elements carried out by a consumer-side control panel; whereby the central control unit of the system is configured to acquire data from the consumer-side control panels.

4. The system of claim 3, wherein said set of hydraulic accumulators comprises multiple interconnected membrane-type storage containers.
